(19) United States
(12) Patent Application Publication
(10) Pub. No.: US 2010/0262524 A1
(43) Pub. Date: Oct. 14, 2010

(54) Contract Administration Support/Audit System (CASAS)

(76) Inventor: Elaine Wu, (US)

Correspondence Address: Elaine Wu, PO Box 121903, Nashville, TN, 37212, US

(21) Appl. No.: 12/420,822

(22) Filed: Apr. 9, 2009

(51) Int. Cl. G06Q 10/00

(52) U.S. Cl. 705/32

(57) ABSTRACT

A computerized system whereby the vendor enters invoice and supporting contract information to generate required report formats to be verified by the system prior to transmission, which when transmitted to the contract administrator permits the contract administrator's system to check for conformance to contract related limits, and whereby upon approval the system updates related information on buyer's system(s) and optionally filters or summarizes top-level data relevant for payer's reporting/archival needs.

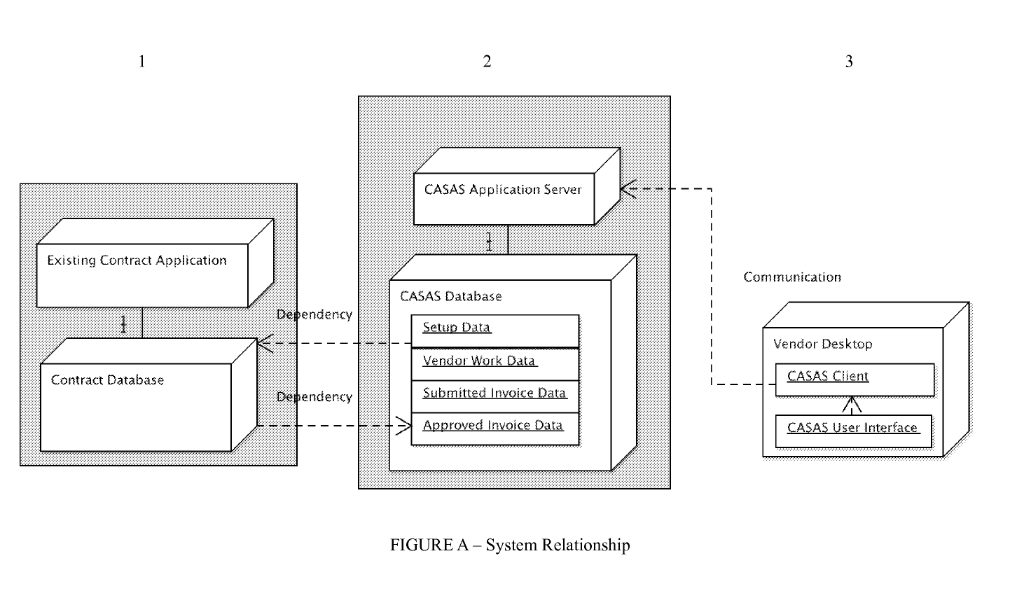

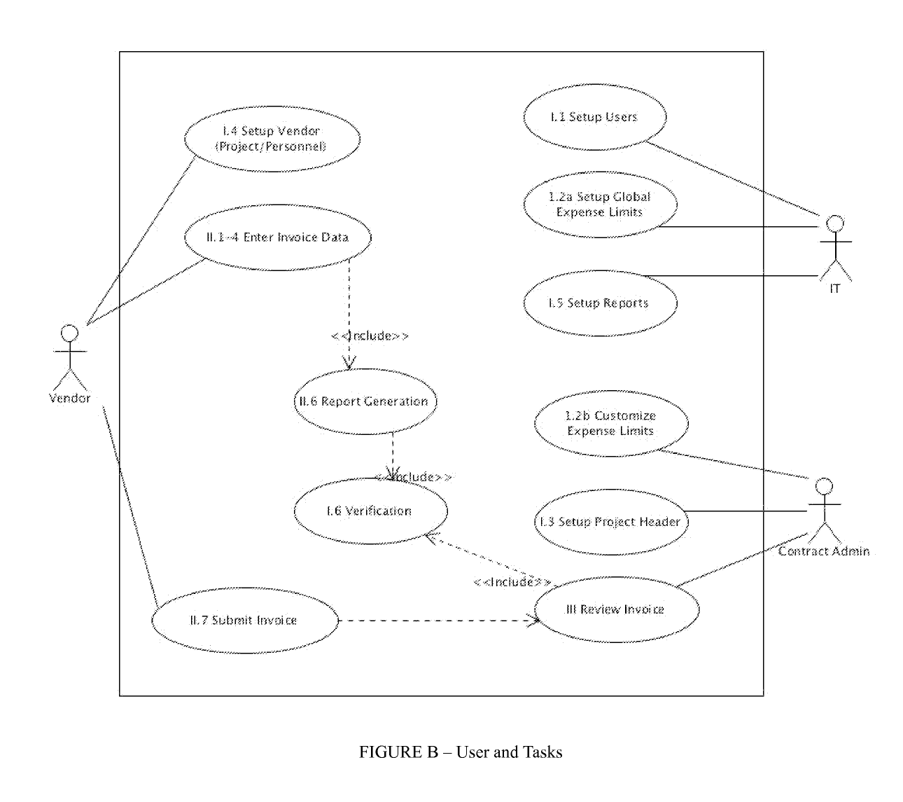

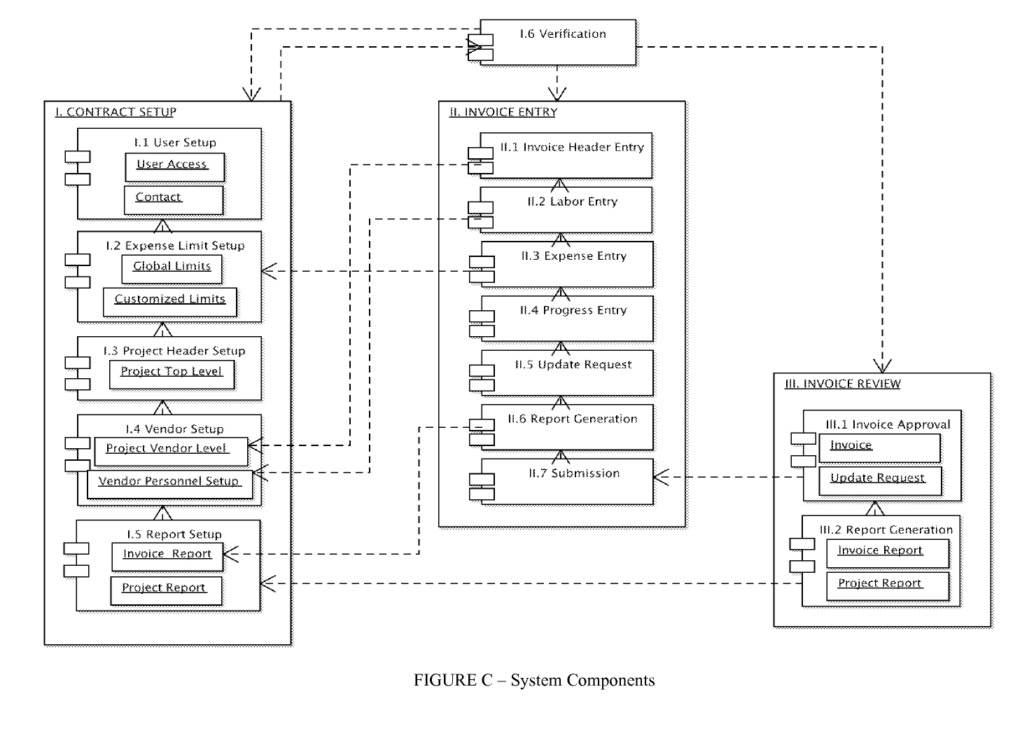

### RELATED APPLICATIONS

This application is a continuation of U.S. Patent Provisional Application Ser. No. 61/043,260 filed on Apr. 8, 2008.

### TECHNICAL FIELD OF THE INVENTION

This invention relates to the field of computer data communication and more particularly to a system and method for production of invoice with contract information for submission, verification, approval/audit and reporting.

### BACKGROUND OF THE INVENTION

Since distributed applications (including web applications) have become popular, many types of forms have been submitted via computer or via the world-wide web interface. Despite the popularity of such applications, submissions of detailed invoices requiring contract support information remain mostly a manual process, both on the vendor completion side and buyer's verification and reporting side.

Most contract administration systems do not incorporate highly detailed invoice information due to cost of maintaining such data. These systems store contract information necessary for ongoing contract maintenance, such as contractual amount and timing, amount paid to date and per period amount paid with progress. To enter invoice-level detailed data would require more internal personnel. Furthermore, unless the additional data is well maintained it could lose accuracy, as well as slow down internal system access time.

Contract administration system with invoice module can be setup for vendor data entry. However, in practice the buyer enters the invoice data himself, due to security reasons and potential typo errors that may directly conflict with vendors' data. For example, the contract data residing at buyer's site should only be accessible by buyer, since if the vendor were granted permission to modify, the vendor could edit sealed agreement at will. Furthermore, if one vendor were to mistype a contract number, its associated invoice could accidentally match to another vendor's contract number. Likewise, invoice numbers sometimes assigned to by client to a vendor could be mistyped and cause mismatch of vendor invoices.

Existing vendor-centric invoice systems which generate reports for contract maintenance/audit are neither compatible nor integrated with client's contract administration systems. This means a vendor would first enter invoice information for his internal accounting, then manually enter invoice information on client's invoice forms for cost reimbursements.

In the case where client and vendor belong to the same organization (such as departmental or subsidiary relationship), customized systems have been created to handle invoice submissions, but are are highly specialized for the organization. For larger organizations, they often lack tightly coupled integration, and usually requiring data download, specialized software to filter out error and to reorganize data, then separately upload the data into client's centralized host.

Even if a client does not require a vendor to fill out a separate form for payment (as it would usually be the case for government contracts), the client needs to manually inspect details of invoice documentation to assure that they adhere to contract agreements, which can be time consuming with construction related invoices that can be 50-100 pages long.

### SUMMARY

It is an object of the current invention to reduce cost by having vendors enter cost and supporting contract data directly in to a system via simplified interface (rather than more complicated invoice form) for direct data transmission to contract administrator's computer (which avoids duplication of data entry), to increase accuracy by having the system verify entries based on preset contract rules (contract and expense limits, approved markups and labor rates, etc.) and requires auditors to verify as part of audit process. Detail data changes are kept up to date in that whenever the vendor requests updates (any individual's labor rate or markup, for example), the vendor must prepare changes and submit for approval. Once the changes are digitally approved, the system reflects the most current data.

### BRIEF DESCRIPTION OF THE DRAWINGS

FIG. A is a block diagram of a computer system which is suitable for implementing the methodologies and systems of the present invention.

FIG. B is a high level user view of different associated tasks illustrating operation of the present invention.

FIG. C is a high level component view illustrating the preferred embodiment of the present invention.

### DETAILED DESCRIPTION OF THE PREFERRED EMBODIMENTS

In this process invention vendors enter detailed billing information directly into the system (via an User Interface (UI)) whereupon the system verifies accuracy according to preset rules, generates required reports and accepts submission only when the accuracy is met. When the contract administrator receives the invoice, it will be mostly free of typical errors associated with complicated invoice preparation, so he can focus on top-level contract adherence requirements, rather than searching out inaccuracies in reporting.

### I. System Perspective

With reference to the various systems and methodologies of the present invention, as described below, aspects of the present invention are described in terms of steps executed or executable on a computer system. Although a variety of different computer systems can be used with the present invention, an exemplary computer system is shown generally in FIG. A.

FIG. A shows buyer's contract system is an independent system 1 which communicates bi-directionally with buyer's invoice system 2, and vendor's invoice entry system 3 communicates to buyer's invoice system 2. In the present embodiment, data from buyer's contract system 1 can be used as baseline check against vendor submitted data in buyer's invoice system 2. Additionally, supporting contract data accompanied approved invoice can be used to update buyer's contract system 1.

FIG. A also shows that in buyer's invoice system 2 the submitted data are kept separately from approved invoice data. Only after the invoice data is approved will be the data be used for update to buyer's contract or invoice system.

### II. User Perspective

FIG. B is an exemplary Use-Case diagram showing users performing typical invoice tasks required for invoice/contract support setup (IT function), invoice preparation (vendor), and approval and reporting (buyer/contract administrator). Numberings for each task corresponds to numbers in Section III Component Perspective.

IT sets up users for access, sets up general expense limits and configures invoice and project reports. Contract Administration sets up project information, customize expense limits and reviews invoices submitted by the Vendor.

In task I.1 IT sets up users to access system. They can be setup by types of users (IT, vendor, contract administrator) and roles (data entry, approval permission, etc.). In this step accompanying computer access authentication information are also specified.

In task I.2a IT sets up global limits applicable to expense allowances. Expenses can be categorized by per diem types, mileage, material prices and so forth.

In task I.5 IT sets up invoice and audit reports. The invoice form is configured here with associated terminologies for respective fields. The form contains data fields to reference underlying database and include any equations for calculation.

Vendor enters invoice data, (which includes setup of personnel labor rates when he first uses the system). The system generates complex invoice reports with verification of invoice data, then the Vendor submits data for Contract Administration review.

In task I.4 vendor sets up his projects (and associated contract support information), as well as list of personnel approved to work for projects.

In task II.1-4 the vendor enters invoice data into the system.

In task II.6 the vendor generates invoice report/form from entered invoice data.

In task II.6 the vendor requests verification of invoice completed.

In task II.7 the vendor submits invoice.

The contract administrator customizes expense settings relevant to his department/agency, sets up and headers associated with contract for invoice payment, and approves or audit invoice.

In task I.2b the contract administrator has option to customize global expense limits.

In task I.3 the contract administrator sets up project header, which are information associated with a particular contract's invoice processing, such as specialized codes and department information.

In task III the contract administrator reviews invoice. The invoice can is separately verified on contract administrator's system as double check and also permits the contract administrator to use local data rather than vendor's data for verification.

### III. Component Perspective

FIG. C system components are functional software units with associated User Interfaces (UI). There are three packages in this embodiment: I. Contract Setup, II. Invoice Entry and III. Invoice Review. Within each package are components of related functions. I.6 Verification is a component that can be set to occur at the detail entry level, at the summary level or at submission level. The Verification component can captures global verification not part of local components. Sample data typically needed to accomplish the invention methodology are included in the description. The underlying database structure should be designed to maximize the system's flexibility.

I. CASAS Contract Setup

The Setup is performed upfront and updated as needed. Vendor related setups are done by Vendor and updated as needed. They are not considered “permanent” until Contract Administration approves them.

I.1 User Setup [User: IT]

The system needs to have authorized users with access rights set up. The following information are typically needed:

a) User Access:
User ID
User Name
Password
User Type (Contract Administration, Vendor, Auditor, IT, etc.)
Project
Access Privilege
Components/Objects Access

b) Contact:
User Contact Information
Additional Security fields

I.2 Expense Limits Setup [User: IT or Contract Administration]

The system needs to be set up to auto-verify expense limits. The underlying data can consist of general cost limits which are customized to override on specific cost types (by categories, locations, projects, etc.). The IT administrator could load the General limits, while contractor administrator could customize according to local and project needs. Example data to setup:

a) General Limits:
Fiscal Year
Expense Category (lodging, mileage, food, etc.)
Expense Description
Expense Location (if needed, such as lodging rates by city)
Expense Limit

b) Customized Limits:
Fiscal Year
Organization
Project
Task/Subtasks (if needed)
Vendor
Expense Category
Expense Description
Expense Location
Expense Limit

I.3 Project Header Setup [User: Contract Administration or IT]

The project header usually appears on each invoice to describe the project. Project level setup is needed to: 1) Define project cost and stakeholders and 2) Facilitate all subsequent Vendor Project setup (I.4.a).

If project level information already exists in digital format (say on a contract system), then they can be uploaded by IT into CASAS. Otherwise, a Contract Administrator can enter manually into CASAS via User Interface.

If for any reason Contract Administration cannot afford time to set this up separately, only the Vendor Level of Project would be setup (I.4), in which case the Vendor Project cost from all Vendors in a project would equal to the total allocated project cost.

Project Level:
Fiscal Year
Project
Project Type
Project Administrator
Department
Approved Project Limit
Tasks and Cost Limits (if applicable)
Subtasks and Cost Limits (if applicable)
Overhead markup rate limit for Vendor and affiliates
Fee markup rate limit
Personnel rate update frequency limit
Required Labor Time Period Reporting (Daily, weekly, monthly, etc.)
Vendors
Any other affiliated Header

I.4 Vendor Setup [User: Vendor]

Vendor Project level header and Personnel labor rates are used to facilitate invoice entry and enable auto-verification. Once setup they automatically populate each new invoice. All Vendor data entries must be submitted and approved by Contract Administration before it is used for verification. Example of data to be gathered are:

a) Project Vendor Level
Vendor
Fiscal Year
Project
Project Type
Project Administrator
Department
Approved Vendor Project Limits
Tasks and Cost Limits (if applicable)
Subtasks and Cost Limits (if applicable)
Approved overhead markup rates for Vendor and affiliates
Approved fee markup rate
Approved personnel rate update frequency
Invoice Type (time & material, lump sum, etc.)
Required Labor Time Period Reporting (Daily, weekly, monthly, etc.)
Any other affiliated Header
Project ID <generated by system>

Project Vendor Level fields have many identical fields from Project Header. These data fields would be generated by the system when Project Header is setup.

b) Vendor Personnel Setup
Project
Name
Function/Title
Personnel Type (employee, affiliate, contractor)
Hourly Rate (If applicable)
Date Approved <contract administrator use only>
Person Approving <contract administrator use only>

I.5 Report Setup [User: IT with Contract Administration Approval]

Two types of reports can be setup: Invoice and Project. The Invoice report conforms to the invoice format and is used to generate Vendor invoices. The Project report can be set up to compile invoice data into project summaries.

Reports need to be set up to populate appropriate Data fields. Data fields usually include project and invoice headers, detail labor/direct cost entries and calculated totals from detailed data. Some report formats can be uploaded while others need to be designed. Once set up it is associated with a project, department, or agency. As with most existing reports generated online, these reports can be saved in digital formats such as pdf, csv, or Excel.

Reports can be setup to accommodate higher level project views, such as by department, state or agency. When highly integrated with an existing contract administration system, forecast/variance reports as well as other financial and audit reports can be made available.

I.6 Verification

Verification occurs on multiple levels at data entry, object or component level within each module. However, there may be additional verification needed on global basis not captured locally. This component is a “catch-all” for any such verification. Verification of contract related terms and expense limits are effected through this component function.

I.7 Communication Setup [User: IT with Contract Administration Direction]

This optional component can be setup to enable seamless transport of data to or from an existing contract system to CASAS. The Communication Path module is used to setup communication parameters between an existing system and CASAS hosted on server(s). The Import/Export setup allows definition of fields necessary for data exchange. The Import function would be useful for bringing Project Header data (I.3) or Vendor Project data (I.4a) into CASAS in mapped digital format, so no manual entries would be required. The Export function would be useful for moving approved invoice data either in summary or detailed level into an existing contract or other data management system.

II. CASAS Invoice Entry [User: Vendor]

The Vendor enters detailed invoice cost information, which usually include invoice information, update request, labor cost, expenses, and progress.

II.1 Invoice Header Entry

An Invoice header is generated whenever a new invoice is created. Invoice period varies by contract. If contract is set up to be a certain period, then only data pertaining to contract requirement will be accepted. Labor hours can be entered as daily, weekly, monthly or other increments. For audit daily hourly total is usually required, although labor entry in weekly can be permitted if daily hours are attached as time sheets. Invoice creation usually include these fields:
Project
Vendor
Invoice Number
Invoice Period (weekly, biweekly, monthly, any)
Invoice Date
Invoice Period From
Invoice Period To
Labor Hour Entry (daily, weekly, monthly, etc.)
Amount Invoiced <generated by system after detailed costs are entered>

II.2 Labor Entry

Most contracts have different markup rates for employees and subcontractors, so they are entered separately. When a Vendor prepares his first invoice in CASAS, he needs to setup his personnel list with rates according to contract agreement (I.4 Vendor Personnel Setup). Once Vendor Personnel rates are setup, labor costs are entered in hours except for lump sum reporting. In lump sum reporting, the interface would permit entry in Amount rather than Hour.

a) Employee Labor
Personnel
Date From
Date To
Task (if applicable)
Subtask (if applicable)
Hour/Amount (used for lump sum contract)

b) Subcontractor Labor
Personnel
Date From
Date To
Task (if applicable)
Subtask (if applicable)
Hour/Amount (used for lump sum contract)

The system can display both the hourly rate and the markup rates. Once the labor entry is complete, the system can also verify the total labor cost against contract limits.

II.3 Expense Entry

Vendor direct costs may include travel expenses, materials and capital equipment purchase. Individual expenses are verified by the system against expense allowed limits (per I.2 Expense Limit Setup). When a claimed expense is above maximum threshold, CASAS uses the maximum amount allowed to calculate invoice expenses. Data usually required are:
Expense Category
Task (if applicable)
Subtask (if applicable)
Personnel (incurring or approving expense)
Description
Part-Number
Quantity
Amount
Allowed Amount (generated by system)

Once the data entry for cost is done, the system will total the cost base on allowed limits and also verify total direct cost against contract limits by tasks/subtasks, if needed.

II.4 Progress Entry

Progress/Milestone section can be either descriptive, numerical or both. This section permits entries for both. If the numerical progress represented is purely financial (completely based on cost incurred), then it is automatically generated as part of report. If the numerical progress, such as percentage completion of work (differentiated from percent of funds expanded), then it would be entered here.
Project
Progress Summary
Task
Subtask
Percent Complete
Detail Description

II.5 Update Request

Vendor may may have need to update personnel labor rates due to cost changes or request additional funding. While the latter require additional forms not part of the invoice system, some contract situations allow for more flexible request. Often rate changes are informally agreed upon and invoices are permitted to show updated cost before a formal approval (which may take months). Upon formal approval, the invoice is then paid. In such situation, it would be desirable to enable the system to produce invoices reflecting update requests prior to formal approval. If a inclusion of update prior to formal approval is not permitted, an update request can still be entered as a note accompany the invoice report. A flag is needed to control how the update appears in the invoice:
Include Update in Invoice (Y/N, allows update to be in current invoice; this field would not be visible if contract does not allow this).

Vendor update requests are entered via Vendor Setup User Interface (I.4). The system generates an update report which accompanies the Invoice Report.

II.6 Report Generation

Invoice generation is done by requesting the system via user interface. The report will appear in the required invoice format per setup. Project level verification can occur here and any errors would be displayed. If changes are needed, Vendor can return to data entry mode to make changes (II.1-II.5).

II.7 Invoice Submission

The submission process includes final verification, optional receipt upload, exception/update request reporting, and printable reports. Vendor can upload scanned receipts to attach to invoice if required or recommended by contract. When a Vendor submits invoice via user interface, if there are errors, the system will not permit submission.

Exception can be built into the system to allow a Vendor to override, if contract allows in such cases as additional funding request when a project has exceeded current cost limit. When an invoice is submitted with exceptions, the invoice will be sent to contract administration with exceptions highlighted. In cases where labor rates updates are allowed prior to formal approval, the invoice will compile updates for separate approval. Some additional data fields required are:
Submit Personnel <generated by system via Login>
Submit Date <generated by system>
Submit Time <generated by system>
Receipt Attached (Y/N)
Receipt (upload)
Update Request <generated by system, see section II.5)Update Request>
Exception <Y/N—generated by system)>
Exception Description <generated by system>

If only Update Request (I.5) is present, then only the Update Request report will be submitted.

III. CASAS Invoice Review

[User: Contract Administrator, Auditor, Accounting, Budgeting]

Users of Invoice Review and Audit module can review invoice via User Interface from the system prior to receiving paper invoice. Once the entire invoice is approved under agreed conditions within the Contract Administrator's organization (such as physical signature is required on paper copies), Accounting can process the invoice for payment and Budgeting can use it to track against actual project spending.

III.1 Invoice Approval

After an invoice is reviewed and approved for payment, Contract Administrator needs to enter approval into the system and the system will log his approval information. If the invoice is reviewed (but pending approval due to open issues) or rejected, the administrator also needs to enter this status. Vendors can then access this on the system instead of calling the Contract Administrator. The rejected invoice will be deleted once a replaced submission takes place.

a) Invoice
Invoice Process Status (Pending Review, Reviewed, Approved, Rejected)
Original Receipt (Y/N)
Ready for Payment (Y/N)
Notes
Approver Name <generated by system from Login>
Date Invoice Approved <generated by system>
Time Invoice Approved <generated by system>

If a Vendor requests updates (usually submitted with the invoice), the Contract Administrator needs to approval status via system's User Interface. When changes are approved, the approver's name, date and time are logged by the system. Digitally approved updates become new rules that the system will use to verify Vendor's subsequent data entries.

b) Update Request
Approval Type (Once, Permanent, Provisional, Rejected)
Update Category
Update Approved (Y/N)
Notes
Task (if applicable)
Subtask (if applicable)
Approver Name <generated by system from Login>
Date Update Approved <generated by system>
Time Update Approved <generated by system>

III.2 Report Generation

Invoice reports can be generated by Vendor Invoice or by Project per report formats configured (I.5). For Invoices summary reports, all approved vendor invoices are included to show status his project. For Project reports, summary of all vendor invoices by labor, expenses, progress can be displayed. If higher level summaries are configured, administrators can view summaries by department, state or agency.

### Advantages

The system speeds up preparation and increases accuracy through simplified user interface for data entry or for upload, compared to many traditional contract form designs. Depending on the complexity of the form, the overall time saved in preparation through simplified interface, automated verification and automated summary reports can range from 25% to 75%. Additional saving is realized from minimizing the resubmit cycle due to errors, a time saver to both contract administration and vendors. As part of automated verification, the cost report is checked for adherence to contract limits by appropriate categories, as well as individual labor rates against approved labor rates.

The system can be programmed with default expense limits by category and location. For example, with government contracts, often Federal expense reimbursements guidelines are used in conjunction with State or Agency guidelines. The system can enforce Federal Guidelines customized with Agency guidelines. With these automated verification, vendors would not have to check for specific limits of expenses across different contract terms or whether an employee's rate has been updated to reflect new cost (or if it could be allowed). Consequently contract administration would save time in correcting errors and avoid having to send the invoice back to the vendor for revision.

This process not only improves the accuracy of submitted invoices, it also reduces preparation time by generating related summary reports, so that the associated contract history and higher level summary reports need not be manually filled-in and verified. Although many Excel invoice forms are set up with detail data linked to multi-leveled summary to automatically populate current summary reports, because accompanying history data often needs to be hand updated at more than one summary level, errors can occur easily. When historical errors multiply and are not caught in time, vendors, as well as administrators can lose track of actual cost expanded and actual funds available for spending.

The process is adaptive to differing levels of reporting requirement so it can be deployed across different government agencies or company-wide. The system can accept and produce reports according to varying time periods (daily, weekly, monthly or arbitrary time period). The system can also handle detailed break down of reporting, such as task and subtask level breakdown for labor and expenses. Some government agencies (or company departments) require multiple reviewer/department information be part of the contract report form, the system can accept input for more than one reviewers detail. Finally, the system can be configured to generate reports with identical formats to existing reports.

The system can be used to support existing contract management systems which contain top-level contract information. When integrated (whether through system communication or data upload), it enables drill down of detail. The ability to drill down in detail and summarize at detail level across organizations (or government agencies) can enhance the organization's ability to uncover cost saving opportunities that otherwise would not be visible (such as in purchasing). The system can also be deployed as a standalone contract management system when it is augmented with features associated with traditional contract management systems (with data still deployed in separate data discs for enhanced security).

Finally, the system can be useful as a transitional tool before a common way of reporting can be established. It can facilitate transition via hosting proposed reporting formats (and still generate reports base on existing formats). When a common format is finalized, the system can continue to host all the data and report on the agreed format. The cost of installing this transitional system is born by the fraction of cost savings from using the system.

The software process is platform independent. It is optimally hosted on the web, as this is the fastest way to submit and obtain cost reports. However, it can be deployed off-line and retain the benefits of greater reporting accuracy.

### Conclusion

The present invention is useful for managing contracts requiring detailed expense reporting. Existing contract administration systems do not incorporate highly detailed invoice information due to cost of maintaining such data. To enter such detailed data would require more internal personnel. Furthermore, unless the additional data is well maintained it could lose accuracy, as well as slow down internal system access time. This new process lowers cost by having vendors enter cost and supporting data directly in to a system via simplified interface (compare to contract form), the system verifies entries based on preset contract rules (contract and expense limits, approved markups and labor rates, etc.) and requires auditors to verify as part of audit process. The detail data changes are kept up to date in that whenever the vendor requests updates (any individual's labor rate or markup, for example), the vendor must prepare changes and submit for approval. Once the changes are digitally approved, the system reflects the most current data. The data throughput and security issue can be handled via having the physical data reside separately from contract administrators in-house data.

The present invention is especially suitable for complex government projects requiring multi-summary and department reporting, where the existing method for vendor to report costs can be error prone (such as with multi-paged Excel spreadsheets). Current contract management systems store only contract information necessary for ongoing contract maintenance, such as contractual amount and timing, amount paid to date and per period amount paid with progress. This leaves detailed management and audit of contract invoices to be manually performed. This manual process can be costly when the contract form is complicated and requires vendors to prepare invoices separately from their in-house systems.

Due to the complicated and multi-leveled contract forms, contract administration also needs to spend considerable time in audit. In addition to the typical summary contract and itemized amounts to verify, it is necessary to verify approved labor rates against claimed rates, which can be fairly involved if a contract has as many as ten tasks and 50 people working.

Finally, since any invoicing error results in return of invoice to vendor for reconciliation, more time is consumed in resubmission and correction, a repetitive cycle which can be costly. This system can also be useful for companies with multi-branches operating as semi-autonomous entities each with separate reporting systems, as well as companies engaged in construction oversight for themselves or others. Construction with frequent need for design revisions are vulnerable to mismanagement when not tracked at detail levels.

What is claimed is:

1. A computerized system which: a) checks electronically submitted invoice for compliance to contract terms, including:
contract maximum amount,
fee rate,
overhead rate,
retainage rate,
projects (optionally with amounts),
task breakdown (optionally with amounts)
labor rates and/or permitted update frequency,
material pricing list, and
expense limits by category;
and
b) provides appropriate alert message(s) when invoice deviates from contract terms or when there is difference between the last approved contract term(s) and the current invoice submission.

2. A computer system configured such that the vendor enters the invoice and related contract supporting data to generate required invoice documents/reports for electronic submission, whereby upon receipt the buyer can approve invoice through either visual inspection or with computer assisted contract term checks, and only upon approval can he initiate one ore more of the following tasks on the buyer's system:
a) update existing invoice and supporting contract data stored on one or more systems,
b) extract top-level data with option to regroup details (to customize by interest or to hide more confidential information such as labor rates) for report generation,
c) store extracted top-level data with option to discard detail data in one or more systems, or
d) communicate approval status to vendor electronically via email or directly to vendor's database.

3. A computer system configured such that vendor's invoice data entry is separated from invoice form used for reporting, where:
a) forms are multi-page linked documents which may contain detailed calculations and subtotals and
b) buyer can approve/audit invoice report either via the generated form or through grouped data summary.
